(19) United States
(12) Patent Application Publication
(10) Pub. No.: US 2019/0302596 A1
(43) Pub. Date: Oct. 3, 2019

(54) OPTICAL MODULE

(71) Applicant: Anteryon Wafer Optics B.V., Eindhoven (NL)

(72) Inventors: Yelena Vladimirovna Shulepova, Eindhoven (NL); Edwin Maria Wolterink, Eindhoven (NL)

(21) Appl. No.: 16/367,615

(22) Filed: Mar. 28, 2019

Related U.S. Application Data
(60) Provisional application No. 62/650,344, filed on Mar. 30, 2018.

(30) Foreign Application Priority Data
Mar. 30, 2018 (NL) 2020697

(51) Int. Cl. G03B 21/20; G02B 1/04; G02B 27/42

(52) U.S. Cl. CPC G03B 21/208; G02B 27/4205; G02B 1/041; G03B 21/2033

(57) ABSTRACT

The present invention relates to an optical module, especially an optical projector module, comprising: at least a light source, an optical lens construction and a diffractive optical element (DOE), wherein said optical lens construction comprises at least a first and a second lens group, said first and second lens group comprising each two lens surfaces, said lens surfaces having different optical properties, wherein said first lens group is positioned adjacent to said light source.

### CROSS-REFERENCE TO RELATED APPLICATIONS

This application claims priority of Provisional Ser. No. 62/650,344, filed Mar. 30, 2018, the disclosure of which is hereby incorporated by reference in its entirety.

### FEDERALLY SPONSORED RESEARCH OR DEVELOPMENT

Not Applicable.

### MICROFICHE/COPYRIGHT REFERENCE

Not Applicable.

### FIELD OF THE INVENTION

The present invention relates to an optical module, especially an optical projector module, comprising at least a light source, an optical lens construction and a diffractive optical element (DOE).

### BACKGROUND OF THE INVENTION

Optical modules are very commonly used in consumer electronic devices. For example, almost all current portable telephones and computers include a miniature camera module. Miniature optical projection modules are being increasingly used in portable consumer devices for a variety of purposes.

In 2017 Apple added a 3D sensing camera to its new iPhone X, starting a new era for the mobile phone industry. It enables real interaction with the external environment and paves the way for authentication, mobile payment systems, augmented reality and virtual reality in your hand. In such an iPhone X five sub-devices are integrated, namely a spectral sensor; a proximity sensor, a flood illuminator; a dot projector and a near-infrared (NIR) camera. The IR dot projector is the structured light “emitter” and produces a pattern of 30,000 infrared dots in front of the smartphone, which illuminate faces so that they can be photographically captured by the NIR camera. The emitter uses four sub-elements to project its dots and brings together a VCSEL laser diode array, a ceramic multi-chip package, an optic made of two wafer level lenses sandwiching a folded optical light guide, and an active diffractive optical element (DOE). These sub-elements are assembled into a tiny prismatic light guide to obtain low-profile projector optics, only 3.7 mm in height.

Systems for mapping of three-dimensional (3D) objects, and specifically to optical 3D mapping have been disclosed in US 2008240502. According to that US publication a pattern of spots is projected onto an object, and an image of the pattern on the object is processed in order to reconstruct a 3D map of the object. The pattern on the object is created by projecting optical radiation through a transparency containing the pattern. Such an apparatus for mapping an object comprises an illumination assembly, comprising a single transparency containing a fixed pattern of spots; and a light source, which is configured to transilluminate the single transparency with optical radiation so as to project the pattern onto the object; an image capture assembly, which is configured to capture an image of the pattern that is projected onto the object using the single transparency; and a processor, which is coupled to process the image captured by the image capture assembly so as to reconstruct a three-dimensional (3D) map of the object.

WO 2016195791 discloses an optical module, comprising: a transparent substrate and a refractive optical element mounted on the substrate. The optical module comprises an emitter, such as a chip containing a laser diode or laser diode array, emitting light (which may be visible, infrared and/or ultraviolet) into an optical module. Lenses in the optical module collimate and direct the light through an optical output element, for example a patterning element 26, such as a diffractive optical element (DOE) or microlens array, so as to produce a pattern of structured light that can be projected onto a scene.

US 2009185274 discloses an apparatus for projecting a pattern, comprising a first diffractive optical element (DOE) configured to diffract an input beam so as to generate a first diffraction pattern on a first region of a surface, the first diffraction pattern comprising a zero order beam; and a second DOE configured to diffract the zero order beam so as to generate a second diffraction pattern on a second region of the surface such that the first and the second regions together at least partially cover the surface.

CN 107741682 relates to a light source projection device comprising a light source, a lens system and a diffraction optical element. This Chinese publication discloses a lens system including a first lens, a second lens, and a third lens, wherein the first lens is a biconvex lens that receives the array incident beam emitted by a plurality of sub-light sources. The second lens is a biconcave lens for diffusing the beam array emitted from the first lens to increase the beam width; and the third lens is a meniscus lens having positive power.

US 2017/187997 relates to a projector comprising: a laser module, for generating a laser beam; and a wafer-level optics, comprising: a first substrate; a first collimator lens manufactured on a first surface of the first substrate, for receiving the laser beam from the laser module to generate a collimated laser beam; and a diffractive optical element, wherein the collimated laser beam directly passes through the diffractive optical element to generate a projected image of the projector; wherein the diffractive optical element is imprinted on a second surface of the first substrate, and the second surface is opposite to the first surface, and spacers.

US 2015/097947 relates to a depth camera system, comprising: an illumination module that outputs structured light that illuminates a capture area; and an image detector module; the illumination module including a VCSEL array comprising a plurality of vertical cavity surface emitting lasers (VCSELs), wherein each of the VCSELs emits a separate beam of light, and wherein the plurality of VCSELs collectively emits a light pattern; and projection optics that receives the light pattern emitted by the VCSELs of the VCSEL array and project the light pattern; wherein the structured light output by the illumination module is created at least in part based on light pattern projected by the projection optics. The projection optics include a field lens and an objective lens, wherein the field lens receives the beams of light emitted by VCSELs of a VCSEL array and converges the beams to a single pupil, wherein the objective lens, which is positioned at the pupil, receives the converged beams from the field lens and diverges the beams to produce the light pattern projected by the projection optics.

US 2016/127713 relates to a projection system configured to emit patterned light along a projection optical axis, the projection system comprising: a diffractive optical element having a first facet and a second facet, the first facet being configured to perform an expansion optical function and the second facet being configured to perform a collimation optical function and a pattern generation function; and a light emitter configured to emit light toward the diffractive optical element, wherein the collimation optical function is configured to collimate the light from the light emitter, and wherein the pattern generation function is configured to replicate the collimated light to produce the patterned light. Because the first facet of the hybrid optical element performs the expansion function and the second facet performs the collimation and pattern generation functions, increasing the spacing between the first facet and the second facet (e.g., increasing the thickness of the optical element) can increase the performance of the hybrid optical element because the thickness of the optical element is a part of the optical length over which the beam diverges.

EP 2 116 882 relates to an imaging lens including a lens block having: a lens substrate that is a plane-parallel plate; and a lens that is contiguous with at least one of the object-side and image-side substrate surfaces of the lens substrate and that exerts a positive or negative optical power, wherein the imaging lens also includes an aperture stop that restricts light amount.

WO 2012/161570 in the name of the present applicant relates to an optical unit comprising, seen in the direction from the object side to the imaging surface, a first lens, a second lens and a diaphragm present in the light path between the first lens and the second lens, wherein the distance [(vertex first lens) and (vertex second lens)] is 250-650 micrometer.

In miniature optical projection modules the dimension so the modules play an important role. The present inventors found that that the reduction of the height of the miniature optical projection modules requires folding of the optics for accommodating a Total Axial Length (TAL) or Total Track Length (TTL) of at least 6.5 mm.

In addition, in a folding construction, such as a periscopic configuration using mirrors, the distance between the diffractive optical element (DOE) and the light source is limited. In that context it should be mentioned that the divergence of the VCSEL light source is below 20 degrees, typically below 15 degrees.

Another disadvantage of these periscopic configuration using mirrors is related to the manufacturing process. Due to the tiny size, in particular below 10 mm, serious manufacturing problems with shape control, alignment and complex assembly processes occur thereby making the manufacturing process very expensive.

Furthermore, a technical requirement of an optical module, especially an optical projector module, is the quality of the spot size, in relation to the value of the TAL.

### SUMMARY OF THE INVENTION

An object of the present invention is thus to develop an optical module, especially an optical projector module, in which complex geometric constructions, including prisms and mirrors, are avoided.

Another object of the present invention is to develop an optical module, especially an optical projector module, having a high quality of the spot size while maintaining tiny dimensions.

The present invention relates thus to an optical module, especially an optical projector module, comprising at least a light source, an optical lens construction and a diffractive optical element (DOE), wherein said optical lens construction comprises at least a first and a second lens group, said first and second lens group comprising each two lens surfaces, said lens surfaces having different optical properties, wherein said first lens group is positioned adjacent to said light source.

One or more of the aforementioned objects are obtained by such an optical module. The size of the present optical module may be such that dimensions of about <10 mm×10 mm×10 mm are possible. The term “different optical properties” comprises one or more of the group of shape, dimension, and material. For example, the materials used for manufacturing the lens surfaces may be the same whereas the shape, e.g., flat vs convex, convex vs concave or flat vs concave, and/or the dimensions of the lens surfaces may be different. Typical optical properties of materials to be used for manufacturing lens surfaces are for example refractive index and Abbe number. In an embodiment of the optical module two or more diffractive optical elements (DOE) are present.

The term “said first and second lens group comprising each two lens surfaces, said lens surfaces having different optical properties,” refers to a situation wherein for a specific lens group comprising two lens surfaces both lens surfaces within that specific lens group have different optical properties.

In an embodiment of the optical module the first lens group comprises a lens surface A and a lens surface B, lens surface A being positioned adjacent to said light source, wherein said lens surface A is of the type convex and said lens surface B is of the type concave.

In an embodiment of the optical module the second lens group comprises a lens surface C and a lens surface D, lens surface C being positioned adjacent to said first lens group, wherein said lens surface C is of the type concave and said lens surface D is of the type convex.

In an embodiment of the optical module the axial length (track length) may be in a range of a maximum of about 10 mm.

In an embodiment of the present invention the optical module comprises an optical lens construction wherein a third lens group is present, said third lens group comprising each two lens surfaces, said lens surfaces having different optical properties.

In an embodiment of such an optical module the third lens group comprises a lens surface E and a lens surface F, wherein lens surface F is positioned adjacent to said diffractive optical element (DOE).

In an embodiment of an optical module the optical lens construction comprises a lens surface A of the type convex, a lens surface B of the type convex, a lens surface C of the type concave, a lens surface D of the type convex or of the type flat, a lens surface E of the type convex or of the type flat, and a lens surface F of the type convex.

In an embodiment of the optical module the range of index (n) of the polymer materials used for the lens surfaces is between 1.45 and 1.6.

In another embodiment of the optical module the range of index (n) of the polymer materials used for the lens surfaces is between 1.6 and 1.8.

In an embodiment of the optical module the refractive index (n) values of lens surface A, lens surface B, lens surface C and lens surface D are the same, i.e., a value within the standard tolerance of the polymer materials.

In an embodiment of the optical module the refractive index (n) values of lens surface A, lens surface B, lens surface C, lens surface D, lens surface E and lens surface F are the same, i.e., a value within the standard tolerance of the polymer materials.

In an embodiment of an optical module the light source is chosen from the group of type of semiconductor laser diode, such as vertical-cavity surface-emitting laser (VCSEL), and any other coherent light source, single or in plural (array).

In an embodiment of an optical module each of said lens groups has been manufactured according replication technology. Such a manufacturing method uses wafer level replication technology. The present lenses are preferably groups of contiguous lens elements cemented together by replication technology, for example manufactured according to WO 20091048320 A1. The contents of WO 20091048320 are considered to be incorporated here in its entirety.

In an embodiment of an optical module the thickness of at least one lens element within the first, second and third lens group is in a range of from about 50 micron to about 400 micron, wherein the thickness is determined by the shortest path of the light rays through a lens group. The thickness is the vertex till the substrate according to the optical axis. The term “lens element” as used in this context here refers to lens surface. In other words, a lens element is an element having an optical function, i.e., a lens function, wherein such an optical function is obtained by a lens surface. A lens surface can thus be seen as a part of a lens element.

In an embodiment of an optical module, especially in the optical lens construction, one or more additional layers are present, chosen from the group of integrated intermediate substrates, IR filters, UV filters, apertures and diaphragms, or combinations thereof.

An example of a substrate material is glass. The thickness of such a glass substrate is equal to or lower than 1.5 mm, preferably equal to or lower than 0.5 mm, and thickness of such a glass substrate is equal to or higher than 0.1 mm, preferably equal to or higher than 0.25 mm. The use of a substrate material is preferred when the lens groups have been manufactured according replication technology. The range of index (n) of the material used for the glass substrate is about 1.52.

The materials of the lens groups are preferably chosen from the group of UV curable polymers, preferably epoxy, acrylic and nylon type polymers. For high refractive index applications can be used: hetero atom (nitrogen, phosphor, halogen, sulphur) containing photopolymers, such as (pentabromophenyl methacrylate, Tribromophenoxyethyl acrylate, phenylthiolethyl acrylate, bis (methacryloyl thiophenyl) sulfide) and urethane methacrylates, and high refractive index nanoparticle modified photopolymers (e.g., TiO2, Sb2O4).

The present invention also relates to a method for projection, comprising: directing an input beam of radiation to pass through an optical module as discussed above, wherein the diffractive optical elements (DOE) is configured to generate a respective plurality of diffraction patterns at the respective beam angles, wherein each of the diffraction patterns comprises a set of spots corresponding to respective diffraction orders of a corresponding one of the output beams and projects a respective diffraction image comprising the spots onto a region in space.

Preferred embodiments of the present invention have been formulated in the dependent claims.

Other objects, features, and advantages of the invention will become apparent from a review of the entire specification, including the appended claims and drawings.

### BRIEF DESCRIPTION OF THE DRAWINGS

The present invention will be explained by using the Figures and embodiments.

FIG. 1 shows a lay out of an embodiment of an optical module.

FIG. 2 shows a spot diagram at 700 mm distance.

FIG. 3 shows a lay out of an embodiment of an optical module.

FIG. 4 shows a spot diagram at 700 mm distance.

FIG. 5 shows a lay out of an embodiment of an optical module.

FIG. 6 shows a spot diagram at 700 mm distance.

FIG. 7 shows a lay out of an embodiment of an optical module.

FIG. 8 shows a spot diagram at 700 mm distance.

FIG. 9 shows a schematic side view of a projection assembly.

### DETAILED DESCRIPTION OF THE PREFERRED EMBODIMENT

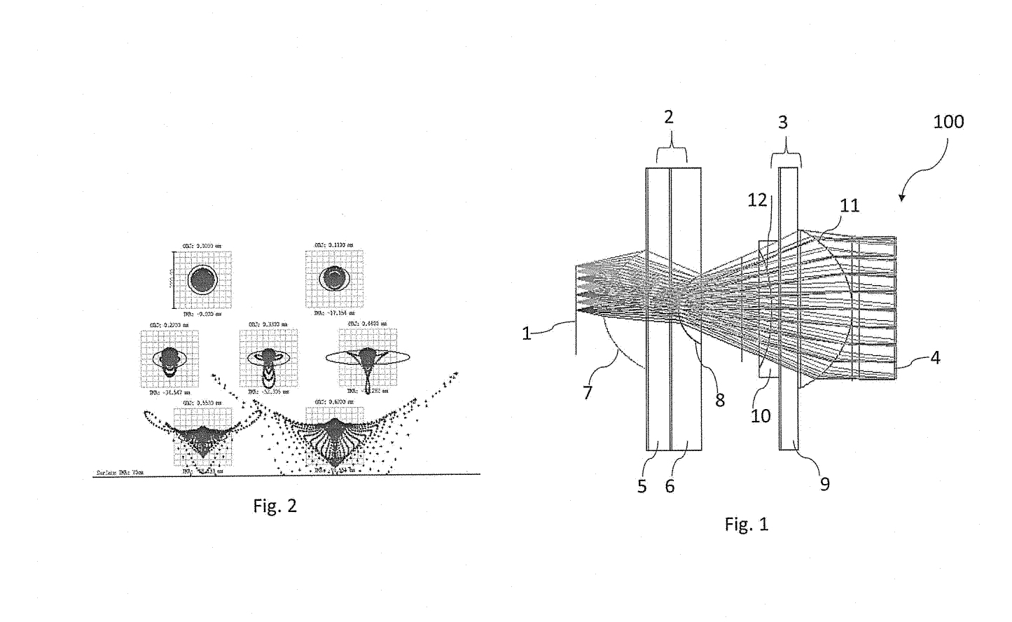

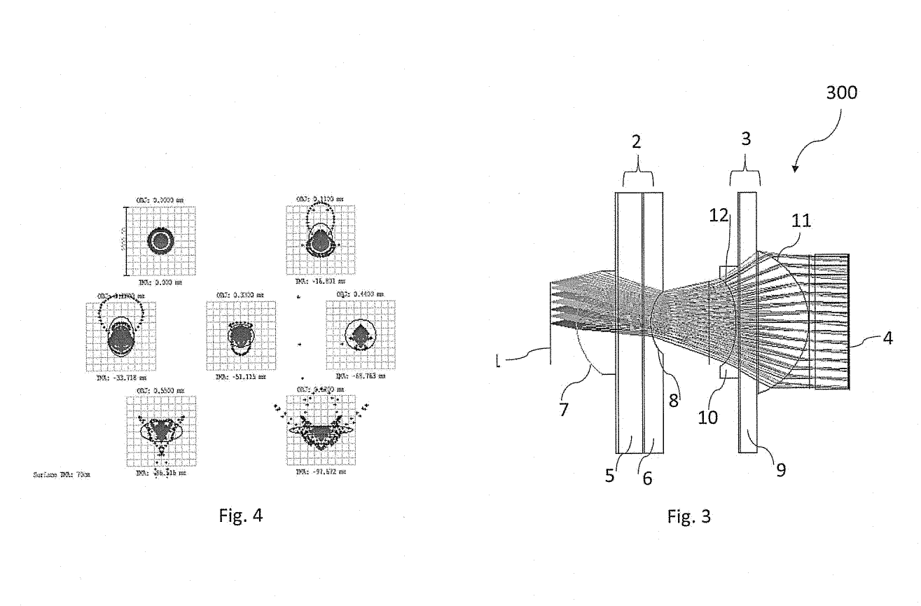

FIG. 1 and FIG. 3 show a lay out of an embodiment of an optical module 100, 300, respectively, comprising a light source 1 and a diffractive optical element 4(DOE), including an optical lens construction positioned there between. The light emitted by the light source passes through the optical lens construction and arrives on the diffractive optical element 4. FIG. 1 and FIG. 3 both show the path of rays through the optical module 100, 300, respectively. The optical lens construction comprises a first lens group 2 and a second lens group 3. The first lens group 2 comprises a lens surface 7 and a lens surface 8. The second lens group 3 comprises a lens surface 12 and a lens surface 11. The first lens group 2 comprises substrate 5 provided with lens surface 7 and polymer layer 6 provided with lens surface 8. Lens group 3 comprises substrate 9 provided on one side thereof with lens surface 11 and on the other side thereof polymer layer 10 provided with lens surface 12. The lens surfaces 7, 8 in first lens group 2 have different optical properties and lens surfaces 12, 11 in second lens group 3 have different optical properties.

FIG. 2 shows a spot diagram at 700 mm distance, obtained with the optical module 100 according to FIG. 1. FIG. 2 refers to a polymer material having a refractive index of 1.55. From FIG. 2 one can see that at 700 mm, 90% of the encircled energy of the spot lies in a radius between 284 and 813 microns in a range of object up to 0.55 mm.

FIG. 4 shows a spot diagram at 700 mm distance obtained with the optical module 300 according to FIG. 3. FIG. 4 refers to a polymer material having a refractive index of 1.68. From FIG. 4 one can see that at 700 mm, 90% of the encircled energy of the spot lies in a radius between 213 and 367 microns in a range of object up to 0.55 mm.

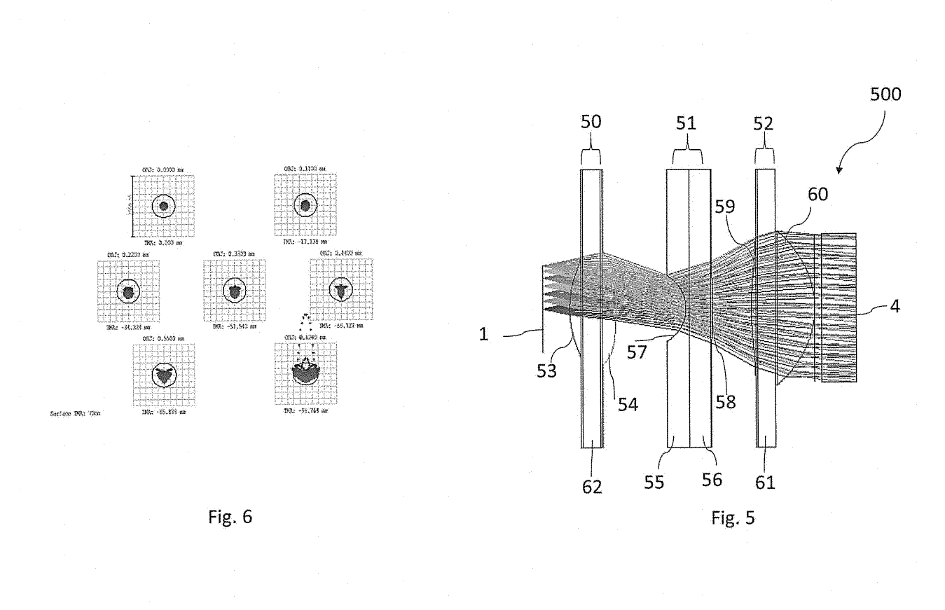

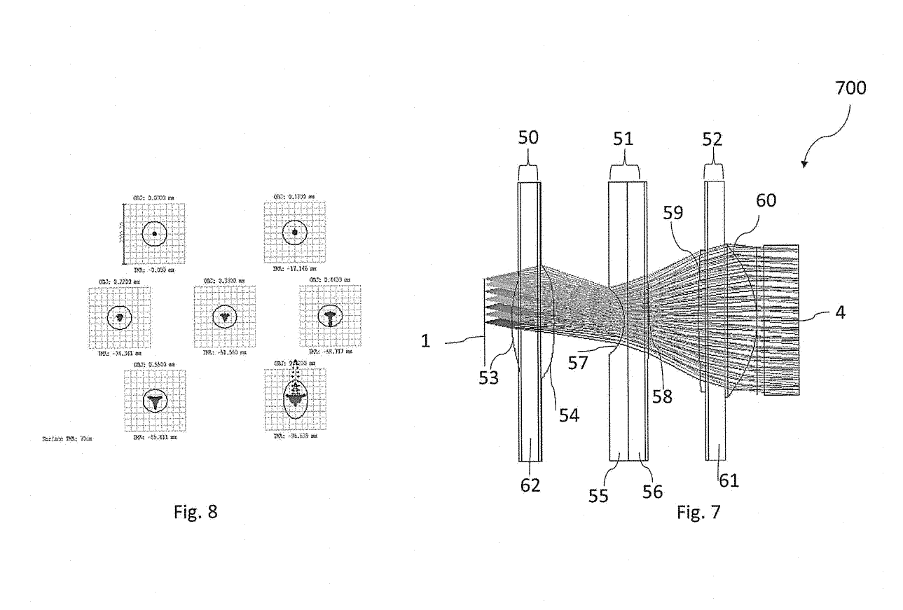

FIG. 5 and FIG. 7 show a lay out of an embodiment of an optical module 500, 700, respectively, comprising a light source 1 and a diffractive optical element 4(DOE), including an optical lens construction positioned there between. The light emitted by the light source passes through the optical lens construction and arrives on the diffractive optical element 4. FIG. 5 and FIG. 7 both show the path of rays through the optical module 500, 700, respectively. The optical lens construction comprises a first lens group 50, a second lens group 51 and a third lens group 52. The first lens group 50 comprises a lens surface 53 and a lens surface 54. The second lens group 51 comprises a lens surface 57 and a lens surface 58. The third lens group 52 comprises a lens surface 59 and a lens surface 60. The first lens group 50 comprises substrate 62 provided with lens surface 53 and lens surface 54. The second lens group 51 comprises substrate 56 provided with lens surface 58, wherein substrate 56 on its other side is provided with polymer layer 55 provided with lens surface 57. Third lens group 52 comprises a substrate 61 provided on one side with a lens surface 59 and on the other side with a lens surface 60. The lens surfaces 53, 54, 57, 58 and 59, 60 within the respective lens group have different optical properties. For example, lens surfaces 53, 54 in first lens group 50, lens surfaces 57, 58 in second lens group 51, and lens surfaces 59, 60 in third lens group 52 have different optical properties, respectively.

FIG. 6 shows a spot diagram at 700 mm distance, obtained with the optical module 500 according to FIG. 5. FIG. 5 refers to a polymer material having a refractive index of 1.55. From FIG. 6 one can see that at 700 mm, 90% of the encircled energy of the spot lies in a radius between 104 and 182 microns in a range of object up to 0.55 mm.

FIG. 8 shows a spot diagram at 700 mm distance obtained with the optical module 700 according to FIG. 7. FIG. 8 refers to a polymer material having a refractive index of 1.68. From FIG. 7 one can see that at 700 mm, 90% of the encircled energy of the spot lies in a radius between 35 and 122 microns in a range of object up to 0.55 mm.

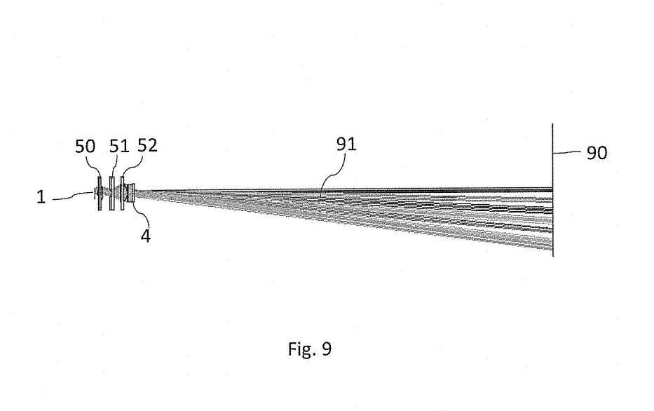

FIG. 9 shows a schematic side view of a projection assembly, wherein the optical module according to FIG. 7 is used. The light emitted by the light source 1 passes through the optical lens construction 50, 51 and 52 and arrives on the diffractive optical element 4. Diffractive element 4 and projects a respective diffraction image 91 comprising the spots onto a region in space 90.

In the Table 1 below the results corresponding to the relevant FIGS. 1, 2, 3, and 4 are shown.

The present inventors found that a highly beneficial effect on the spot diameter (Encircled energy distance) with a Total Axial Length of less than 10 mm can be obtained by an optical module comprising three lens groups. In that context the present inventors found that the most preferred result (See FIG. 7) is obtained by a construction with three lens groups and lens surfaces with high refractive index materials (1.6<n<1.8), wherein the encircled energy distance is in a range of 35-122 microns. In that context the present inventors found that a preferred result (See FIG. 5) is obtained by a construction with three lens groups and lens surfaces with normal refractive index materials (1.4<n<1.6), wherein the encircled energy distance is in range of 104-182 microns. In that context the present inventors found that an acceptable result (See FIG. 3) is obtained by a construction with two lens groups and lens surfaces with a high refractive index (1.6<n<1.8), wherein the encircled energy distance is within a range of 284-367 microns. In that context the present inventors found that a less acceptable result (See FIG. 3) is obtained by a construction with two lens groups and lens surfaces with normal refractive index materials (1.4<n<1.6), wherein the encircled energy distance is within a range of 204-806 microns. On basis of the above the quality criteria can be quantified as, on basis of the value of the encircled energy distance: optimal result (lower than or equal to 100 microns), good result (lower than or equal to 200 microns), acceptable result (lower than or equal to 400 microns) and less acceptable result (higher than or equal to 400 microns).

TABLE 1
data of spot diagram

| | |
|---|---|
| | Encircled energy |
| Object height | distance (in micrometres) |

| (mm) | FIG. 2 | FIG. 4 | FIG. 6 | FIG. 8 |
|---|---|---|---|---|
| 0.0 | 354 | 367 | 104 | 35 |
| 0.11 | 334 | 335 | 120 | 47 |
| 0.22 | 306 | 365 | 147 | 65 |
| 0.33 | 284 | 356 | 146 | 71 |
| 0.44 | 347 | 213 | 167 | 106 |
| 0.55 | 813 | 324 | 182 | 122 |

The present optical module can be used in a projection assembly, for example a projection assembly as shown in FIG. 2 of US 2017/116757. FIG. 2 is a schematic side view of a projection assembly, said assembly comprises a light source, such as a laser diode, which generates and projects an input beam of radiation (possibly collimated) via optics onto a surface. The optics generate a pattern on the surface. The present optical module can be used as the optics used in the projection assembly as shown in FIG. 2 of US 2017/116757, In an embodiment of the present projection assembly the divergence and fan-out angles are chosen so that the multiple adjacent instances of the pattern tile the region. In one such embodiment, the divergence angle of each instance of the pattern is 2βTile, and the fan-out angle between the adjacent instances is βFO, and the divergence and fan-out angles are chosen so that sin(βFO)=2 sin(βTile).

Optical designs for the optical elements and simulation and for the optical functions of the DOE elements are obtained through ray tracing (e.g., Zemax) software. These calculations provide the input for the shapes and positions of to the disclosed lens elements to be manufactured. The Zemax tables below provide the necessary parameters to reproduce the optical surfaces disclosed in the embodiments of this invention. Design rules and methods for designing a light source array and for the related DOE elements are disclosed in US 20170116757 and in U.S. Pat. No. 9,740,019. Specific software is used for designing the shapes of the optical surfaces of the DOE elements. The optical elements and DOE elements can be manufactured by molding techniques such as injection molding, glass machining and preferably by wafer level replication and stacking technologies.

Optical table for embodiment shown in FIG. 7

| Surf | Type | Radius | Thickness | Glass | Diameter | Conic | Comment |
|---|---|---|---|---|---|---|---|
| OBJ | STANDARD | Infinity | 0 | | 1.24 | 0 | |
| 1 | STANDARD | Infinity | 0.393 | | 1.24 | 0 | VCSEL |
| 2 | EVENASPH | 2.037 | 0.09946294 | 1.680000, | 1.462131 | −1 | Lens1 |
| | | | | 31.039477 | | | |
| 3 | STANDARD | Infinity | 0.03 | 1.680000, | 1.462126 | 0 | |
| | | | | 3.1039477 | | | |
| 4 | STANDARD | Infinity | 0.25 | 1.523303, | 4 | 0 | |
| | | | | 54.517200 | | | |
| 5 | STANDARD | Infinity | 0.03 | 1.680000, | 4 | 0 | |
| | | | | 31.039477 | | | |
| 6 | STANDARD | Infinity | 0.2 | 1.680000, | 4 | 0 | |
| | | | | 31.039477 | | | |
| 7 | EVENASPH | −5.130.351 | 0.9986968 | | 1.625884 | −1 | Lens2 |
| 8 | EVENASPH | −0.8016205 | 0.04912147 | 1.680000, | 0.9718772 | −1 | Lens3 |
| | | | | 31.039477 | | | |
| 9 | STANDARD | Infinity | 0.25 | 1.523303, | 4 | 0 | |
| | | | | 54.517200 | | | |
| 10 | STANDARD | Infinity | 0.05 | 1.680000, | 4 | 0 | |
| | | | | 31.039477 | | | |
| 11 | EVENASPH | 8.664.556 | 0.71412 | | 1.309833 | −1 | Lens4 |
| 12 | EVENASPH | 9.453.521 | 0.1 | 1.680000, | 2.017816 | −1 | Lens5 |
| | | | | 31.039477 | | | |
| 13 | STANDARD | Infinity | 0.03 | 1.680000, | 2.049987 | 0 | |
| | | | | 31.039477 | | | |
| 14 | STANDARD | Infinity | 0.25 | 1.523303, | 4 | 0 | |
| | | | | 54.517200 | | | |
| 15 | STANDARD | Infinity | 0.03 | 1.680000, | 2.191584 | 0 | |
| | | | | 31.039477 | | | |
| 16 | STANDARD | Infinity | 0.4272262 | 1.680000, | 2.205481 | 0 | |
| | | | | 31.039477 | | | |
| 17 | EVENASPH | −1.542.253 | 0 | | 2.205293 | −1 | Lens6 |
| 18 | STANDARD | Infinity | 0.095 | | 2.121541 | 0 | |
| 19 | STANDARD | Infinity | 0.5 | D263TECO | 2.107238 | 0 | |
| 20 | STANDARD | Infinity | 0.005 | B_T200 | 2.155982 | 0 | DOE |
| | | | | | | | layer1 |
| STO | STANDARD | Infinity | 0.015 | | 2.156859 | 0 | |
| 22 | STANDARD | Infinity | 0.005 | B_T200 | 2.160958 | 0 | DOE |
| | | | | | | | layer2 |
| 23 | STANDARD | Infinity | 0.25 | D263TECO | 2.161835 | 0 | WF DOE |
| 24 | STANDARD | Infinity | 700 | | 2.20673 | 0 | 70 cm |
| IMA | STANDARD | Infinity | | | 193.4828 | 0 | |

Surface Data Detail:

Surface 2 EVENASPH Lens1

Coefficient on r\hat{ }2: 0

Coefficient on r\hat{ }4: 0.13456762

Coefficient on r\hat{ }6: −0.39250038

Coefficient on r\hat{ }8: 0.11830958

Coefficient on r\hat{ }10: 0.0026660196

Coefficient on r\hat{ }12: 0

Coefficient on r\hat{ }14: 0

Coefficient on r\hat{ }16: −3.004171

Surface 7 EVENASPH Lens2

Coefficient on r\hat{ }2: 0

Coefficient on r\hat{ }4: −0.10988134

Coefficient on r\hat{ }6: −0.19081945

Coefficient on r\hat{ }8: −0.043912361

Coefficient on r\hat{ }10: −0.10785524

Coefficient on r\hat{ }12: 0

Coefficient on r\hat{ }14: 0

Coefficient on r\hat{ }16: 0

Surface 8 EVENASPH Lens3

Coefficient on r\hat{ }2: 0

Coefficient on r\hat{ }4: −1.3158862

Coefficient on r\hat{ }6: −0.21448231

Coefficient on r\hat{ }8: 0.54505085

Coefficient on r\hat{ }10: 0.091160591

Coefficient on r\hat{ }12: 0

Coefficient on r\hat{ }14: 0

Coefficient on r\hat{ }16: 0

Surface 11 EVENASPH Lens4

Coefficient on r\hat{ }2: 0

Coefficient on r\hat{ }4: −0.57728887

Coefficient on r\hat{ }6: 1.0888944

Coefficient on r\hat{ }8: −0.75314998

Coefficient on r\hat{ }10: 0.14336034

Coefficient on r\hat{ }12: 0

Coefficient on r\hat{ }14: 0

Coefficient on r\hat{ }16: 0

Surface 12 EVENASPH Lens5

Coefficient on r\hat{ }2: 0

Coefficient on r\hat{ }4: −0.03608994

Coefficient on r\hat{ }6: −0.0053503229

Coefficient on r\hat{ }8: 0.026280754

Coefficient on r\hat{ }10: −0.0077499762

Coefficient on r\hat{ }12: 0

Coefficient on r\hat{ }14: 0

Coefficient on r\hat{ }16: 0

Surface 17 EVENASPH Lens6

Coefficient on r\hat{ }2: 0

Coefficient on r\hat{ }4: −0.020004263

Coefficient on r\hat{ }6: −0.0027490732

Coefficient on r\hat{ }8: −0.006209157

Coefficient on r\hat{ }10: 0.0055039559

Coefficient on r\hat{ }12: 0

Coefficient on r\hat{ }14: 0

Coefficient on r\hat{ }16: 0

The lens numbers shown above correspond to FIG. 7, i.e., Lens1 corresponds to reference number 53, Lens2 corresponds to reference number 54, Lens3 corresponds to reference number 57, Lens4 corresponds to reference number 58, Lens5 corresponds to reference number 59, Lens6 corresponds to reference number 60, respectively.

The reference numbers mentioned in FIG. 7 and the information provided in the Zemax Surface are as follows:

| Reference number FIG. 7 | Zemax Surface (Table 2) |
|---|---|
| 53 | 2 (lens 1) |
| 54 | 7 (lens 2) |
| 57 | 8 (lens 3) |
| 58 | 11 (lens 4) |
| 59 | 12 (lens 5) |
| 60 | 17 (lens 6) |

From the foregoing, it will be observed that numerous modifications and variations can be effected without departing from the true spirit and scope of the novel concept of the present invention. It is to be understood that no limitation with respect to the specific embodiments illustrated herein is intended or should be inferred. The disclosure is intended to cover, by the appended claims, all such modifications as fall within the scope of the claims.

1. An optical module, especially an optical projector module, comprising:
at least a light source, an optical lens construction and a diffractive optical element (DOE), wherein said optical lens construction comprises at least a first and a second lens group, said first and second lens group comprising each two lens surfaces, said lens surfaces having different optical properties, wherein said first lens group is positioned adjacent to said light source.

2. An optical module according to claim 1, wherein said first lens group comprises lens surface A and lens surface B, lens surface A being positioned adjacent to said light source, wherein said lens surface A is of the type convex and said lens surface B is of the type concave.

3. An optical module according to claim 1, wherein said second lens group comprises lens surface C and lens surface D, lens surface C being positioned adjacent to said first lens group, wherein said lens surface C is of the type concave and said lens surface D is of the type convex.

4. An optical module according to claim 1, wherein the range of index (n) of the polymer materials used for the lens surfaces is between 1.45 and 1.6.

5. An optical module according to claim 1, wherein the range of index (n) of the polymer materials used for the lens surfaces is between 1.6 and 1.8.

6. An optical module according to claim 1, wherein the axial length (track length) is at most 10 mm.

7. An optical module according to claim 1, wherein said optical lens construction further comprises at least a third group, said third lens group comprising each two lens surfaces, said lens surfaces having different optical properties.

8. An optical module according to claim 7, wherein said third lens group comprises lens surface E and lens surface F, lens surface F being positioned adjacent to said diffractive optical element (DOE).

9. An optical module according to claim 8, wherein said lens surface A is of the type convex, said lens surface B is of the type convex, said lens surface C is of the type concave, said lens surface D is of the type convex or of the type flat, said lens surface E is of the type convex or of the type flat, said lens surface F is of the type convex.

10. An optical module according to claim 1, wherein said at least a light source is chosen from the group of type of semiconductor laser diode, such as vertical-cavity surface-emitting laser (VCSEL), and coherent light sources, single or in plural (array).

11. An optical module according to claim 1, wherein each of said lens groups has been manufactured according replication technology.

12. An optical module according to claim 7, wherein the thickness of at least one lens element within the first, second and third lens group is in a range of from about 50 micron to about 400 micron, wherein the thickness is determined by the shortest path of the light rays through a lens group.

13. An optical module according to claim 1, wherein in one or more of each lens groups one or more additional layers are present, chosen from the group of integrated intermediate substrates, IR filters, UV filters, apertures and diaphragms, or combinations thereof.

14. An optical module according to claim 1, wherein the materials of each of said lens elements are chosen from the group of UV curable polymers, preferably epoxy, acrylic and nylon type polymers.

15. An optical module according to claim 1, wherein said optical properties are chosen from the group of shape, dimension, and material, or a combination thereof.

16. An optical module according to claim 7, wherein said optical module comprises three lens groups, said lens surfaces being made of high refractive index materials (1.6<n<1.8).

17. An optical module according to claim 7, wherein said optical module comprises three lens groups, said lens surfaces being made of normal refractive index materials (1.4<n<1.6).

18. An optical module according to claim 1, wherein said optical module comprises two lens groups, said lens surfaces being made of high refractive index (1.6<n<1.8).

19. A method for projection, comprising:
directing an input beam of radiation to pass through an optical module according to any one more of the preceding claims, wherein the diffractive optical elements (DOE) is configured to generate a respective plurality of diffraction patterns at the respective beam angles, wherein each of the diffraction patterns comprises a set of spots corresponding to respective diffraction orders of a corresponding one of the output beams and projects a respective diffraction image comprising the spots onto a region in space.
